(19) United States
(12) Patent Application Publication
(10) Pub. No.: US 2024/0402019 A1
(43) Pub. Date: Dec. 5, 2024

(54) THERMOMETER WITH IMPROVED MEASUREMENT ACCURACY

(71) Applicant: Endress+Hauser Wetzer GmbH+Co. KG, Nesselwang (DE)

(72) Inventors: Daniel Koch, Oy-Mittelberg (DE); Christian Peuker, Immenstadt (DE); Dietmar Saecker, Nesselwang (DE)

(21) Appl. No.: 18/576,415

(22) PCT Filed: Mar. 18, 2022
(86) PCT No.: PCT/EP2022/057113

§ 371 Date: Aug. 12, 2024

(30) Foreign Application Priority Data
Jul. 8, 2021 (DE) 10 2021 117 715.4

(51) Int. Cl. G01K 1/16; G01K 13/02

(52) U.S. Cl. CPC G01K 1/16; G01K 13/02

(57) ABSTRACT

An apparatus for determining and/or monitoring at least the temperature of a medium in a containment comprises a first temperature sensor for registering temperature and a heating/cooling element for heating/cooling a predeterminable region of the apparatus in which at least the first temperature sensor is located. The first temperature sensor and the heating/cooling element are arranged in such a manner that in an on/in the containment arranged state of the apparatus a distance between the first temperature sensor and a center of the containment is less than a distance between the heating/cooling element and the center.

The invention relates to an apparatus for determining and/or monitoring at least temperature, flow, e.g. volume or mass flow rate, or flow velocity of a medium in a containment, for example, for application in automation technology. The containment can be, for example, a container or a pipeline.

Thermometers are known in a wide variety of embodiments in the state of the art. Thus, there are thermometers, which, for measuring temperature, use the expansion of a liquid, a gas or a solid of known coefficient of expansion, or such, which relate the electrical conductivity of a material, or a variable derived therefrom, with the temperature, such as, for example, electrical resistance in the application of resistance elements or the thermoelectric effect in the case of thermocouples. In contrast, in the case of radiation thermometers, especially pyrometers, the heat radiation of a substance is utilized for determining its temperature. The measuring principles of these measuring devices are described in further detail in a large number of publications.

In the case of temperature sensors in the form of resistance elements, there are, among others, so-called thin film- and thick film sensors, as well as so-called hot conductors (also known as NTC thermistors). In the case of a thin film sensor, especially a Resistance Temperature Detector (RTD), for example, a sensor element is used equipped with connection wires and applied on a substrate, wherein the rear face of the support substrate is, as a rule, coated with metal. Used as sensor elements are so-called resistance elements, for example, in the form of platinum elements, which are obtainable commercially, among others, under the designations PT10, PT100, and PT1000.

In the case of temperature sensors in the form of thermocouples, in turn, the temperature is determined by a thermovoltage, which occurs between unilaterally connected thermocouple wires of different materials. Applied as temperature detector for temperature measurement are usually thermocouples of the DIN standard IEC584, e.g. thermocouples of type K, J, N, S, R, B, T or E. However, also other material pairs are possible, especially such having a measurable Seebeck effect.

The accuracy of temperature measurement depends sensitively on the particular thermal contacts and on the heat conduction present in each case. The heat flows between the medium, the containment, in which the medium is located, the thermometer and the process environment play deciding roles. For a reliable temperature determination, it is important that the temperature sensor and the medium be essentially in thermal equilibrium, at least for a certain time required for registering temperature. The time for reaction of a thermometer to a temperature change is also referred to as response time of the thermometer.

A high accuracy of measurement can be achieved especially when the temperature sensor is immersed in the medium of interest. Thus, numerous thermometers are known, in the case of which the temperature sensor more or less directly contacts the medium of interest. In this way, a comparatively good coupling between the medium and the temperature sensor can be achieved and temperature gradients between the temperature of the medium and the temperature in the immediate vicinity of the temperature sensor are comparatively small.

For various processes and for many containments, especially small containers or pipelines, however, a non-invasive determining of temperature is advantageous. Thus, there are likewise thermometers, which can be secured on the containment, in which the medium is located, and in the case of which the temperature sensor only indirectly contacts the medium. Such devices, also called surface thermometers or contact sensors, are disclosed, for example, in DE102014118206A1, or DE102015113237A1. For assuring a good thermal coupling, then various additional aspects must be taken into consideration, such as, for example, a good mechanical and therewith also thermal contact between container and thermometer. In the case of insufficient contact, an exact temperature determination is not possible. A central problem for non-invasive temperature determination is generally the heat conduction from the process to the environment. This leads, in given cases, to a significantly greater measurement error than in the case of a direct introduction of a temperature sensor into the process.

A similar problem results, for example, also for the case of a thermal measuring principle based, flow measuring device for determining flow or flow velocity of a medium in a pipeline. Such field devices typically comprise at least two sensor elements with at least one temperature sensor and at least one heating element or heatable temperature sensor. The sensor elements can both be introduced into the pipeline, as well as also be integrated in or on a measuring tube (non-invasive construction).

Starting from the described problem of heat conduction regarding accuracy of measurement of temperature sensors, an object of the invention is to provide for temperature determination apparatus and method distinguished by a high accuracy of measurement, especially thermometers and measuring devices for determining flow or flow velocity.

The object is achieved by an apparatus for determining and/or monitoring at least temperature of a medium in a containment, comprising a first temperature sensor for registering temperature, and a heating/cooling element for heating/cooling a predeterminable region of the apparatus, in which region at least the first temperature sensor is located.

According to the invention, the first temperature sensor and the heating/cooling element are arranged in such a manner that in an on/in the containment arranged state of the apparatus a distance between the first temperature sensor and a center of the containment is less than a distance between the heating/cooling element and the center. The heating/cooling element is, thus, arranged closer to the environment than the temperature sensor. The containment is, for example, a container or a pipeline. The center can, depending on embodiment of the containment, be either a midpoint of the containment, for example, in the case of a container, or a central axis in the containment, for example, in the case of a pipeline.

The apparatus can optionally further comprise an electronics, for example, a transmitter. Alternatively, the electronics can also be a separate component, connectable with the apparatus. An option is especially also use of an apparatus of the invention with a 4-20 mA electronics, e.g. a 4-20 mA transmitter. The apparatus can correspondingly also be embodied as a two-conductor field device.

Moreover, the apparatus can, depending on embodiment, also comprise yet other components, for example, securement means for securing individual components to a wall of the containment, or, in the case of an invasive thermometer, a protective tube. Possible especially is also a use of an apparatus of the invention

By means of the heating/cooling element, the effects of a heat conduction between medium and environment, thus, an arising temperature gradient, can be attenuated or minimized. A temperature gradient occurs, when the temperature of the medium differs from the temperature of the environment of the apparatus, especially the environment of the first temperature sensor. The greater the difference between these two temperatures, the steeper is the temperature gradient and the greater is the resulting measurement error. By means of the heating/cooling element, a temperature gradient arising in the region of the temperature sensor can be canceled.

The preventing of these so-called heat conduction errors is a fundamental goal in the field of industrial temperature determination, independently of whether a thermometer or a flow measuring device is involved. In the case of invasive thermometers in this connection, often a process minimum immersion depth is used, which usually amounts to at least 10 times the thermometer diameter. In the case of a thermal contact degraded, for example, by the use of a protective tube, the minimum immersion depth should amount to even more than 10 times the thermometer diameter. In the case of block calibrators, the minimum immersion depth usually amounts to fifteen times the diameter of the reference thermometer used for calibration. In the case of a non-invasive temperature determination, in contrast, other measures must be applied for assuring a uniform temperature situation for a sensor element. This is, however, because of the very nonuniform heat input in the case of such a measurement, significantly more complex than in the case of an invasive temperature determination.

The apparatus of the invention can involve either an invasive or a non-invasive apparatus. In the case of an invasive apparatus, in the case of which the first temperature sensor is immersed in the medium, the heating/cooling element is preferably arranged a predeterminable distance from the first temperature sensor and its position has a lesser distance from a wall of the containment. In the case of a non-invasive apparatus, the first temperature sensor is preferably arranged in a state of the apparatus secured on the containment between the containment and the heating/cooling element. The first temperature sensor is preferably arranged on the wall of the containment.

An embodiment provides that the first temperature sensor is a resistance element, a thermocouple or a hot conductor.

Another embodiment provides that the heating/cooling element is a resistance element, a Peltier element, a film heating element or an inductive heating element.

It is, additionally, advantageous that the apparatus includes at least one reference element for in situ calibration and/or validation of at least the first temperature sensor, especially a reference element secured on a support element and composed at least partially of at least one material, which, at least in the relevant temperature range for calibrating the first temperature sensor, undergoes at least one phase change at at least one predetermined phase transformation temperature, wherein in the case of the phase change the material remains in the solid state. In this regard, comprehensive reference is taken to EP02612122B1.

In an embodiment of the apparatus, the first temperature sensor and the heating/cooling element are arranged in a shared measuring probe. Preferably, in such case, the first temperature sensor is arranged in an end region of the measuring probe. The heating/cooling element is preferably arranged in a middle region of the measuring probe. Preferably, at least the first temperature sensor is located between the end region and the heating/cooling element.

However, also numerous other embodiments of arrangements at least of the first temperature sensor and the heating/cooling element provide options, which likewise fall within the scope of the invention. For example, an alternative embodiment of an apparatus of the invention provides that the first temperature sensor is arranged in a measuring probe, and the heating/cooling element is arranged outside of the measuring probe, especially securably externally of the measuring probe or of a protective tube, into which the measuring probe is introducible. The first temperature sensor is accordingly placed in a measuring probe, especially a measuring probe according to the state of the art. The heating/cooling element is arranged outside of the measuring probe. For example, the heating-cooling element can be applied externally on the measuring probe. It can, however, be placed in a protective tube of the apparatus, into which the measuring probe is introducible.

It is, additionally, advantageous that at least the heating/cooling element is arranged in a housing. The housing can be, for example, a cuff, which is securable on the measuring probe, or an additional measuring probe for receiving the heating/cooling element.

In an additional embodiment, the apparatus includes a second temperature sensor, which is arranged at a predeterminable distance from the first temperature sensor. The second temperature sensor serves preferably for ascertaining a temperature gradient resulting from heat conduction from the process to the environment or vice versa. Based on a difference between the temperatures determined by means of the two temperature sensors, a temperature gradient in the region of the first temperature sensor can be ascertained.

The first and second temperature sensors can be arranged together in a measuring probe, in given cases, also together with the heating/cooling element. It is, however, likewise an option that the temperature sensors and/or the heating/cooling element are arranged at least partially separately from one another. In the case, in which the heating/cooling element is arranged, for example, in a housing, the second temperature sensor can, for example, also be arranged in the housing, in a measuring probe for the first temperature sensor or separately from the first temperature sensor and the housing.

An embodiment provides that the first temperature sensor comprises a temperature sensitive sensor element, which is electrically contacted via at least first and second connection lines, wherein the first connection line is divided into first and second sections, wherein the first, sensor element near section is composed of a first material, and wherein the second, sensor element far section is composed of a second material differing from the first material, wherein the second connection line is composed of the second material, and wherein the first section of the first connection line and at least one part of the second connection line form a temperature difference sensor in the form of a thermocouple. In this connection, comprehensive reference is taken to DE102018116309A1. With such an embodiment of the temperature sensor, a heat conduction in the region of the temperature sensor can be registered directly and immediately. An exact knowledge of heat conduction further improves the accuracy of measurement of the apparatus.

Furthermore, an embodiment of the apparatus of the invention includes a control unit for controlling the heating/cooling unit by means of a settable heating/cooling signal. The control unit can be, for example, part of the electronics or a separate component of the apparatus.

In an additional embodiment, the apparatus includes a unit comprising, at least partially, a material with anisotropic thermal conductivity, which is especially arranged and/or embodied in such a manner that it, at least partially, surrounds at least the first temperature sensor. In this connection, comprehensive reference is taken to DE102017100267A1.

Likewise advantageously, the apparatus can include a coupling element for securement to the containment. The coupling element comprises a basic body having a contact area, which is embodied in such a manner that the basic body can be applied via the contact area flushly on the containment, wherein the basic body includes a bore for receiving at least the first temperature sensor, and wherein a longitudinal axis of the bore extends tangentially to the contact area. As regards the coupling element, comprehensive reference is made to DE102021109410.0 unpublished as of the earliest filing date of this application.

As regards the coupling element, an embodiment of the apparatus of the invention provides that the heating/cooling element is, at least partially, introduced into, or integrated in, the coupling element. Preferably, the heating/cooling element is introduced into a region of the coupling element, which, in the state of the coupling element on the containment, has a greater distance from the containment than the first temperature sensor.

The object of the invention is achieved, furthermore, by a method for determining and/or monitoring temperature by means of an apparatus of the invention, comprising method steps as follows:
registering temperature of the medium by means of a first temperature sensor, and
heating or cooling a predeterminable region of the apparatus, in which region at least the first temperature sensor is located, by means of a heating/cooling unit.

In an embodiment of the method of the invention, a heating/cooling signal for the heating/cooling element is selected in such a manner that a temperature gradient is minimized in the predeterminable region. Especially involved is a temperature gradient resulting from different temperatures of the medium and the environment. Preferably, the heating/cooling signal is selected in such a manner that an essentially constant temperature reigns in the predeterminable region.

Advantageously, the heating/cooling element is controlled by means of a settable heating/cooling signal. This involves a settable heating/cooling signal, which is adaptable especially to different situations in the environment of the apparatus.

It is, additionally, advantageous that the heating/cooling signal be set as a function of a temperature difference value ascertained by means of the first and second temperature sensors or by means of the temperature difference sensor. The temperature difference value can be either an absolute temperature difference or a relative temperature difference.

It is, finally, likewise advantageous that the heating/cooling signal be so set that the temperature difference value ascertained by means of the first and second temperature sensors or by means of the temperature difference sensor is minimized, thus, especially approaches zero or is essentially zero.

The apparatus can be, for example, a thermometer or a thermal flowmeter. In the case of a thermal flowmeter, on the one hand, the heating/cooling element can also serve for determining the flow, which can be expressed as a volume flow or a mass flow, or a flow velocity. Alternatively, the apparatus can, however, also have a supplemental heating element, which can be used for determining flow or flow velocity.

In the case of thermal flowmeters, the flow or flow velocity can be determined in two different ways. According to a first measuring principle, a sensor element is heated in such a manner that its temperature remains essentially constant. In the case of known, and, at least at times, constant, properties of the medium, such as the temperature of the medium, its density or composition, the mass flow of the medium through the pipeline can be ascertained based on the heating power needed for keeping the temperature at the constant value. The temperature of the medium, in such case, is that temperature, which the medium has without an additional heat input from a heating element. In the second measuring principle, in contrast, the heating element is operated with constant heating power and the temperature of the medium measured downstream from the heating element. In such case, the measured temperature of the medium leads to the mass flow. There are yet other measuring principles, for example, so-called transient methods, in the case of which the heating power or the temperature is modulated.

It is to be noted here that the embodiments described in connection with the apparatus of the invention can be applied mutatis mutandis also to the method of the invention and vice versa.

The invention will now be explained in greater detail based on the appended drawing. The figures of the drawing show as follows:

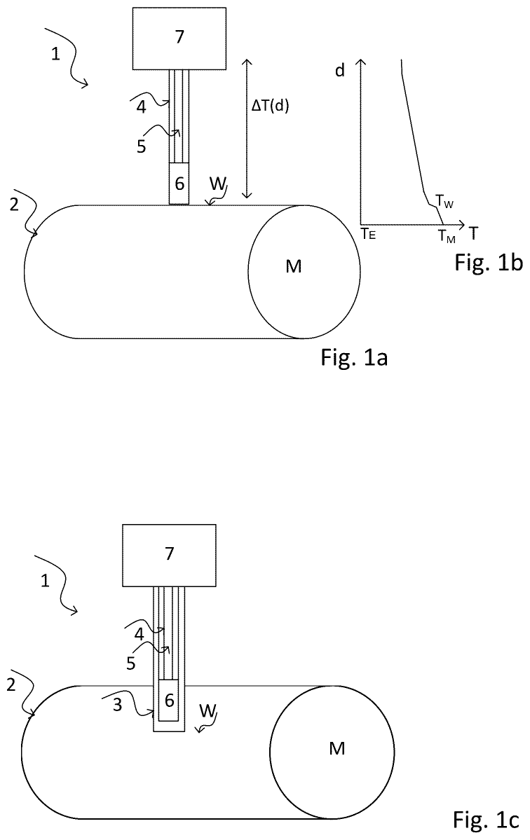

FIG. 1 (a) a thermometer for non-invasive temperature measurement, (b) a schematic view of the arising heat conduction, and (c) a thermometer for invasive temperature measurement according to the state of the art;

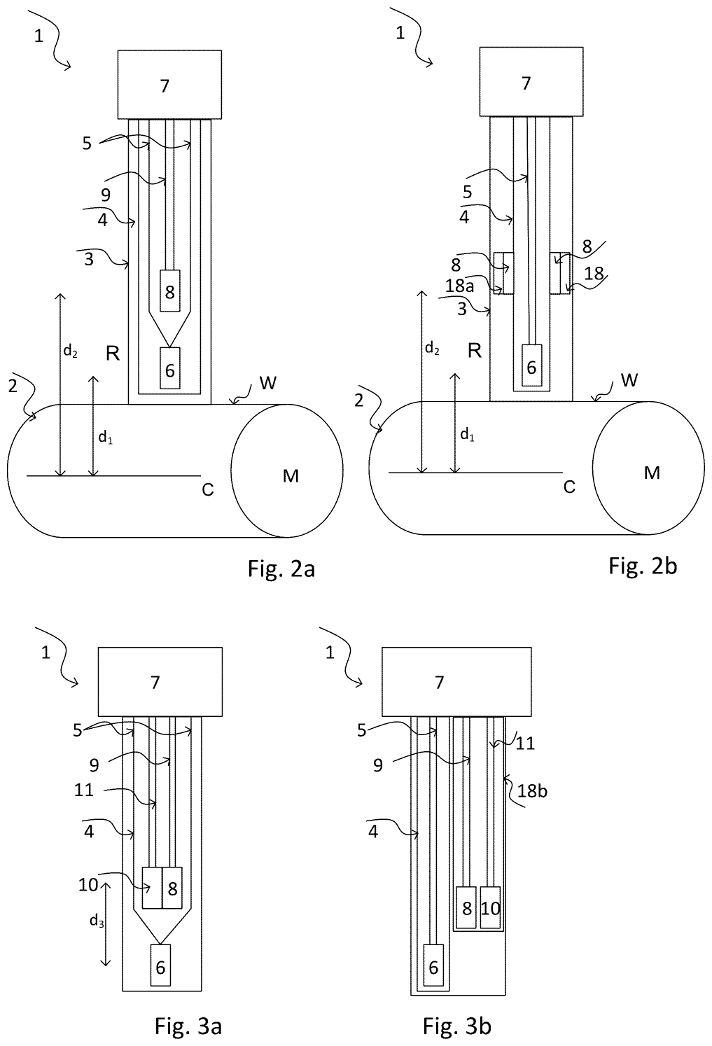

FIG. 2 preferred embodiments for a thermometer according to the invention with a first temperature sensor and a heating/cooling element, wherein (a) the first temperature sensor and the heating/cooling element are arranged together in a measuring probe and (b) separately from one another;

FIG. 3 preferred embodiments for a thermometer of the invention with two temperature sensors, wherein (a) the first temperature sensor and the heating/cooling element are arranged together in a measuring probe and (b) separately from one another;

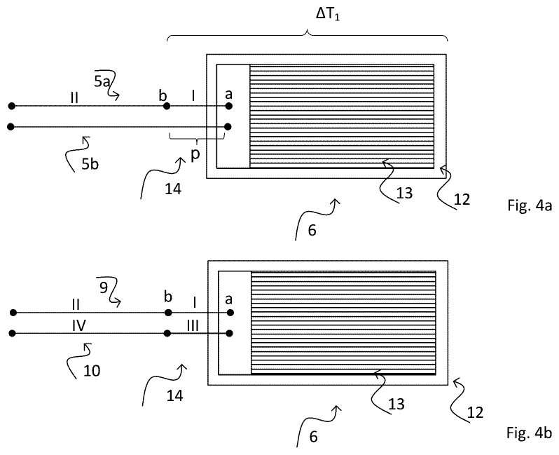

FIG. 4 by way of example, embodiment of a thermometer having a temperature difference sensor for determining heat flow; and

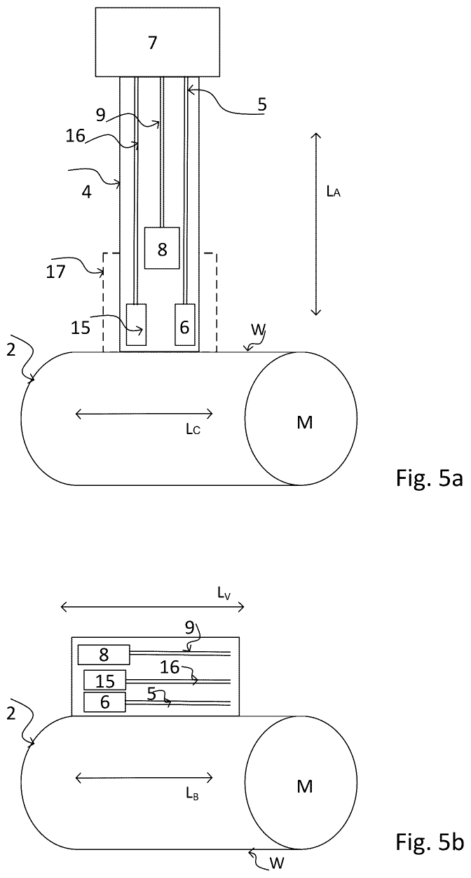

FIG. 5 preferred embodiments for an apparatus of the invention in the form of a thermal flowmeter.

In the figures, equal elements are provided with equal reference characters. The embodiments of the different figures can, furthermore, be combined with one another to the extent desired.

Without intending to limit the general applicability of the invention, the following description concerns thermometers. The various considerations can be directly transferred to other types of field devices, such as thermal flowmeters.

Shown in FIG. 1a is a schematic view of a thermometer 1 according to the state of the art for registering temperature T of a medium M in a containment 2 in the form of a pipeline. In this case, the thermometer 1 does not extend into the pipeline 2, but, instead, is applied externally on a wall W of the pipeline 2 for non-invasive temperature determination.

Thermometer 1 comprises a measuring probe 4 and an electronics 7. The measuring probe comprises a temperature sensor 6, which in the present case is provided as a temperature sensitive element in the form of a resistance element. Temperature sensor 6 is electrically contacted and connected with the electronics 7 via the connection lines 5. While the illustrated thermometer 1 is embodied in compact construction with integrated electronics 7, in the case of other thermometers 1, the electronics 7 can also be arranged separately from the measuring probe 4. Also, the temperature sensor 6 does not necessarily need to be a resistance element and the number of connection lines 5 does not necessarily need to be two. Rather, the number of connection lines 5 can be suitably selected according to the applied measuring principle and applied temperature sensor 6.

As already indicated, the accuracy of measurement of such a thermometer 1 depends greatly on the heat conduction effects and possibly present temperature gradients ΔT between the medium M and an environment of the thermometer 1. The occurrence of such temperature gradients ΔT(d) is illustrated, by way of example, in FIG. 1b as a function of distance d from the medium M.

Medium M has the temperature T_{M}, which for the illustrated example is greater than the temperature T_{E} of the environment. A part of the heat of the medium M is conducted via the container wall W, such that the temperature T_{W} registered in the region of the external surface of the wall W of the containment 2 is lower than the temperature of the medium T_{M}. Also, typically a heat loss takes place between the wall W and the thermometer 1 and propagates to the electronics 7. Thus, the temperature T registered by means of a contact sensor 1 is usually less than the actual temperature of the medium T_{M}.

Similar problems can also result for apparatuses 1 working invasively for temperature determination, such as illustrated in FIG. 1c, which in contrast to the thermometer 1 shown in FIG. 1a, have supplementally an optional protective tube 3 protruding into the medium M and serving for receiving a measuring probe 4.

In order suitably to handle the problems of heat conduction to or from the location of measurement, according to the invention, a heating/cooling element 8 is supplementally provided. Two preferred embodiments for a thermometer 1 of the invention are shown in FIG. 2. In supplementation of the thermometer 1 shown in FIG. 1a, the thermometer 1 of FIG. 2a includes, arranged above the temperature sensor 6, a heating/cooling element 8, which in the illustrated example is likewise contacted by two connection lines 9.

The first temperature sensor 6 has in such case a first distance d₁ from a center C in the form of a central axis (longitudinal axis through the pipeline 2 through a midpoint of its, in such case, circularly shaped, cross sectional area), which is less than a distance d₂ of the heating/cooling element from the center C. In this way, by means of the heating/cooling element 8 a predeterminable region R of the apparatus 1, where at least the first temperature sensor 6 is located, can be suitably heated/cooled, in such a manner that a temperature gradient ΔT in this region R can be reduced or eliminated. In the case of the embodiment illustrated in FIG. 2b, in contrast to the embodiment of FIG. 2a, the heating/cooling element is arranged outside of the measuring probe 4. In such case, the heating/cooling element 8 is arranged in a housing 18a in the form of a cuff, which is securable around the measuring probe 4, and, thus, surrounds the measuring probe 4. Also in such case, a distance d₂ of the heating/cooling element 8 from the center C is greater than a distance d₁ of the first temperature sensor 6 from the center. Alternatively, the heating/cooling element 8 can, for example, also be secured on an interior of the protective tube 3 or arranged in some other manner. The heating/cooling unit 8 can be contacted via the same electronics 7 as the first temperature sensor 6 or via a separate electronics (not shown).

It is to be noted here that besides these illustrated embodiments also other embodiments of the apparatus 1 as well as arrangements of the apparatus 1 relative to the containment 2 are possible and fall within the scope of the invention. Especially, a longitudinal axis of the apparatus 1, especially of the measuring probe 3, can be oriented with an angle other than 90°, especially parallel, to the wall of the containment 2 or longitudinal axis of the containment 2.

The embodiment of FIG. 3 of the apparatus 1 includes supplementally a second temperature sensor 10, which is likewise contacted, by way of example, via two connection lines 11, and which is arranged above and at a predeterminable distance d₃ from the first temperature sensor 6, thus has, in the state of the apparatus 1 arranged on the containment a greater distance from the center C than the first temperature sensor 6. For the embodiment shown by way of example in FIG. 3a, in the case of which the two temperature sensors 6, 10 and the heating/cooling element 8 are arranged together in a measuring probe 4, the distances of the heating/cooling element 8 and the second temperature sensor 10 from the center C are essentially equal. In other embodiments the two temperature sensors 6, 10 and the heating/cooling element 8 can, however, also be arranged in other ways relative to one another.

In the case of the embodiment shown in FIG. 3b, the second temperature sensor 10 and the heating/cooling element 8 are arranged outside of the measuring probe 4 containing the first temperature sensor 6. For this variant, the second temperature sensor 8 and the heating/cooling element 8 are located in a housing 18b, in such case, in the form of an additional measuring probe. Alternatively, for example, also in such case, an arrangement analogous to the embodiment of FIG. 2b is possible.

Supplementally or alternatively, it is, additionally, also an option so to embody the first 6 and/or second temperature sensor 10 that a temperature difference sensor is formed by means of the connection lines, such as shown in FIG. 4 based on two possible embodiments. A temperature sensor 6 in the form of a resistance element 13 applied on a substrate 12 serves for determining and/or monitoring temperature T of the medium M. Temperature sensor 6 is electrically contacted by means of the two connection lines 5a and 5b and is, thus, operated using a so-called two-conductor circuit. In the present case, the two connection lines 5a and 5b are brought directly to the resistance element 13. Let it be noted, however, that, in such case, basically all contactings known to those skilled in the art are possible for connection of the temperature sensor 6 with the connection lines 5.

The first connection line 5a is divided into a first section I and a second section II. The first section I is composed, in such case, of a first material, and the second section II as well as the second connection line 5b are composed of a second material differing from the first material. In this way, the first section I the first connection line 5a and at least one part p of the second connection line 5b form a first temperature difference sensor 14 in the form of a thermocouple. The two materials for the first section I of the first connection line 5a and the second section II of the first connection line 5a as well as for the second connection line 5b are selected in such a manner that, due to a temperature difference between the points a and b, and the correspondingly different thermovoltages forming in the sections due to the thermoelectric effect, a thermovoltage is detectable by means of the temperature difference sensor 14.

The first section I of the first connection line 5a is preferably short compared with total length of the first connection line 5a, for example, the length of the first section I of the first connection line 5a lies in the range of a few millimeters or centimeters. In this way, it can be assured that the values ascertained by means of the first temperature difference sensor 14 reflect a temperature gradient ΔT₁ in the region of the temperature sensor 6 as accurately as possible.

In the case of the example illustrated in FIG. 4a, the first connection line 5a and the second connection line 5b are brought separately to the resistance element 13. The first section I of the first connection line 5a and the part p of the second connection line 5b are, thus, connected indirectly via the resistance element 13. In another embodiment, the first section I of the first connection line 5a and the part p of the second connection line 5b could, however, also be directly connected together and then brought to the temperature sensor 6.

In the embodiment shown in FIG. 4b, also the second connection line 5b is divided into a first III and a second section IV. The first temperature difference sensor 14 is, in such case, formed by the first sections I and III of the first 5a and second 5b connection lines. As shown in FIG. 4b, but not necessary, the two first sections I and III of the two connection lines 5a and 5b are of equal length. The second sections II and IV of the first 5a and second 5b connection lines are, in such case, preferably equally embodied, extension wires. However, also in the case of the embodiment of FIG. 4a, advantageously, the second section II of the first connection line 5a and the second connection line 5b are equally embodied.

By means of the temperature difference sensor 14, a heat flow W can be detected in the region of the temperature sensor 6, which is directly related to an arising temperature gradient ΔT.

Both by means of embodiments of the apparatus of the invention having at least a second temperature sensor 10 as well as also with a temperature difference sensor 14, temperature gradients occurring in the predeterminable region R can accordingly be directly experimentally determined. In such case, a heating/cooling signal for the heating/cooling element 8 is suitably controlled, such that such temperature gradients ΔT can be reduced or eliminated. This procedure improves the accuracy of measurement of the apparatus significantly. Alternatively, it is, however, also possible to ascertain or to estimate the temperature gradients based on a formula or provided reference curves.

FIG. 5 relates, finally, to two apparatuses 1 of the invention in the form of thermal flowmeters. Thus, FIG. 5a shows a thermal flowmeter 1, which, analogously to the apparatus 1 in the form of a thermometer in FIG. 2, comprises a first temperature sensor 6 with connection lines 5 (here, by way of example, two connection lines; the number can vary from embodiment to embodiment) and a heating/cooling element 8 with connection lines 9. Moreover, a heating unit 15 is provided, which is electrically contacted via the connection lines 16. Heating/cooling element 8 serves for reducing, or eliminating, the influence of undesired heat conduction, while heating unit 15 serves for determining flow or flow velocity according to the above explained thermal measuring principle. Although FIG. 5a relates to a non-invasive embodiment of the apparatus 1, such an embodiment can serve both for an invasive as well as also for a non-invasive determining of the flow, especially a volume- or mass flow, or flow velocity. Optionally, the apparatus 1 can additionally have a thermal insulation 17, which effects a thermal shielding of the apparatus 1, at least of the first temperature sensor 6 and the heating unit 15, from the environment.

While in the case of the embodiment shown in FIG. 5a a longitudinal axis L_{A} of the apparatus 1 extends perpendicularly to a longitudinal axis L_{C} of the containment 2, in the case of FIG. 5b, the longitudinal axis L_{A} of the apparatus 1 is oriented in parallel with the longitudinal axis L_{C} of the containment 2.

Also, apparatuses 1 of thermal flowmeters can supplementally have a second temperature sensor 10 or a temperature difference sensor 14. Then advantageously, a heating signal for the heating/cooling element remains constant during the registering of measured values for determining flow or flow velocity. Especially advantageously, in a first operating mode, a suitable heating/cooling signal for the heating/cooling element is ascertained, for example, as a function of a temperature difference value ascertained by means of the first 6 and second temperature sensor 10 or by means of the temperature difference sensor 14. In this regard, it is especially advantageous that during the first operating mode the heating unit 16 remains unheated. In a second operating mode, then preferably the heating/cooling signal for the heating/cooling element is kept constant.

In summary, by means of the apparatus of the invention, it can be achieved that little heat is removed to the environment via the measuring probe 4. Since the predeterminable region R, in which at least the first temperature sensor 6 and at least one section of the connection lines 5 and, in given cases, the heating element 15 and a section of the connection lines 16, are located, is suitably heated/cooled, especially in such a manner that a temperature gradient ΔT in this region is reduced, or minimized, measurement error due to heat conduction can be minimized.

In the case of use of a second temperature sensor 10 or a temperature difference sensor 14, a simple control loop can be provided, by means of which a heating/cooling signal for the heating/cooling element can be set as a function of a temperature difference of the temperature difference sensor 14 or a temperature difference between the first temperature sensor 6 and the second temperature sensor 10.

### LIST OF REFERENCE CHARACTERS

1 apparatus
2 containment
3 protective tube
4 measuring probe
5 connection lines of first temperature sensor
6 first temperature sensor
7 electronics
8 heating/cooling element
9 connection lines of heating/cooling element
10 second temperature sensor
11 connection lines of second temperature sensor
12 substrate
13 resistance element
14 temperature difference sensor
15 heating unit
16 connection lines of heating/cooling element
17 insulation
18 housing for heating/cooling element; 18a in the form of a cuff; 18b in the form of an additional measuring probe
M medium
T temperature
W wall of the containment
R predeterminable region of the apparatus
C center of the containment
d distances between the temperature sensors, the heating/cooling element and the center
ΔT temperature gradient
I,II sections of the connection lines
L longitudinal axis

1-15. (canceled)

16. An apparatus for determining and/or monitoring a temperature of a medium in a containment, comprising:
a first temperature sensor for registering the temperature; and
a heating/cooling element for heating/cooling a predeterminable region of the apparatus in which the first temperature sensor is located;
wherein the first temperature sensor and the heating/cooling element are arranged such that when arranged on or in the containment, a first distance between the first temperature sensor and a center of the containment is less than a second distance between the heating/cooling element and the center of the containment.

17. The apparatus) as claimed in claim 16, further comprising:
at least one reference element for in situ calibration and/or validation of the first temperature sensor).

18. The apparatus as claimed in claim 16,
wherein the first temperature sensor and the heating/cooling element are arranged in a shared measuring probe.

19. The apparatus as claimed in claim 16,
wherein the first temperature sensor is arranged in a measuring probe and the heating/cooling element is arranged outside of the measuring probe.

20. The apparatus as claimed in claim 19,
wherein at least the heating/cooling element is arranged in a housing.

21. The apparatus as claimed in claim 16, further comprising:
a second temperature sensor arranged at a predeterminable distance from the first temperature sensor.

22. The apparatus as claimed in claim 16,
wherein the first temperature sensor includes a temperature sensitive sensor element electrically contacted via a first connection line and a second connection line,
wherein the first connection line is divided into a first section composed of a first material and a second section composed of a second material differing from the first material,
wherein the second connection line is composed of the second material, and
wherein the first section of the first connection line and at least one part of the second connection line form a temperature difference sensor in the form of a thermocouple.

23. The apparatus as claimed in claim 16, further comprising:
a control unit for controlling the heating/cooling element with a settable heating/cooling signal.

24. The apparatus as claimed in claim 16, further comprising:
a unit at least partially comprising a material with anisotropic thermal conductivity, wherein the unit is arranged and/or embodied such that it at least partially surrounds the first temperature sensor.

25. The apparatus as claimed in claim 16, further comprising:
a coupling element for securement to the containment,
wherein the coupling element includes a basic body having a contact area that is embodied such that the basic body can be applied via the contact area flushly on the containment,
wherein the basic body has a bore for receiving at least the first temperature sensor, and a longitudinal axis of the bore extends tangentially to the contact area.

26. A method for determining and/or monitoring a temperature of a medium in a containment, comprising:
providing an apparatus for determining and/or monitoring the temperature of the medium in the containment, including:
a first temperature sensor for registering the temperature; and
a heating/cooling element for heating/cooling a predeterminable region of the apparatus in which the first temperature sensor is located;
wherein the first temperature sensor and the heating/cooling element are arranged such that when arranged on or in the containment, a first distance between the first temperature sensor and a center of the containment is less than a second distance between the heating/cooling element and the center of the containment;
registering the temperature of the medium via the first temperature sensor; and
heating or cooling the predeterminable region of the apparatus in which the first temperature sensor is located with the heating/cooling element.

27. The method as claimed in claim 26,
wherein a heating/cooling signal for the heating/cooling element is selected in such a manner that a temperature gradient is minimized in the predeterminable region.

28. The method as claimed in claim 27,
wherein the heating/cooling element is controlled via a settable heating/cooling signal.

29. The method as claimed in claim 28,
wherein the heating/cooling signal is set as a function of a temperature difference value ascertained by the first and a second temperature sensor or by a temperature difference sensor.

30. The method as claimed in claim 29,
wherein the heating/cooling signal is so set that the temperature difference value ascertained by the first and second temperature sensors or by the temperature difference sensor is minimized.
